(19) United States
(12) Patent Application Publication
(10) Pub. No.: US 2006/0044133 A1
(43) Pub. Date: Mar. 2, 2006

(54) Alarm triggered shut off appliance system (ATSAS)

(76) Inventor: Yunchao Lou, West Bloomfield, MI (US)

Correspondence Address: Arnold S. Weintraub;The Weintraub Group, P.L.C., Suite 240, 32000 Northwestern Highway, Farmington Hills, MI, 48334, US

(21) Appl. No.: 10/929,818

(22) Filed: Aug. 30, 2004

(51) Int. Cl. G08B 1/00; F16K 31/04; H02B 1/24; G08B 29/00; G08B 17/00; G08B 17/10; G08B 21/00

(52) U.S. Cl. 340/531; 340/506; 340/679; 340/628; 340/632; 307/116; 137/78.1; 340/584

(57) ABSTRACT

The Alarm Triggered Shut off Appliance System (ATSAS) relates to a safe control shut-off system for all utility appliances. It reduces the risks of fire and carbon monoxide poisoning before they occur by turning off utility appliances when the smoke detection/carbon monoxide alarms sound. As the alarms sound, the ATSAS automatically shuts off the appliance. This helps the occupants to take emergency action in the earliest stages of development of a fire/carbon monoxide breakout or prevents their occurrences when the occupant's direct action is impossible. The system has a tone decoder that is responsive only to the frequency range of the alarm's alert sound. The tone decoder prevents the system from being falsely activated by erroneous sounds. Once a smoke or gas leak occurs, the system detects the alert sound through its microphone, and energizes a relay or solenoid valve that turns off the supply line to the utility appliance.

### CROSS REFERENCE TO RELATED APPLICATIONS

U.S. Patent Documents

| | | | |
|---|---|---|---|
| 4,070,670 | January, 1978 | Chen; Ho Chi. | 126/42 |
| 4,524,304 | June, 1985 | Todd; Carl D. | 315/156 |
| 4,617,555 | October, 1985 | Sheiman; Arthur E. | 340/531 |
| 4,570,155 | February, 1986 | Skarman; John S. | 340/531 |
| 4,834,188 | May, 1989 | Silverman; Robert R. | 169/65 |
| 5,625,345 | April, 1997 | Stark; Patrick B. | 340/628 |
| 5,651,070 | July, 1997 | Blunt Thomas. | 381/56. |

### BACKGROUND OF THE INVENTION

The present invention, the alarm triggered shut off appliance system, relates to an alarm activated switch device that shuts off the utility supply line for appliances to prevent fire occurrences/carbon monoxide poisoning in response to the sound of an activated alarm such as smoke, carbon monoxide, or heat alarms. It can be used for all utility appliances (cook stoves or ranges, microwave, iron etc.) in residential homes, commercial buildings, ships, and aircrafts.

There were 1,734,500 fires in the United States in 2001. Forty eight point five percent of those fires started in apartment buildings and twenty five point five percent of the fires started in residential homes. Cooking has become the leading cause of house fires in the United States. It is also the leading cause of home fire injuries. These fires result from unattended cooking, human errors, or mechanical/electric failures causing the loss of lives, injuries, and billions of dollars lost on property damage.

(Source: National Fire Protection Association 2001 Fire Loss in the U.S., National Fire Protection Association 2001 U.S. Fire Problem, National Fire Protection Association Home Fire Casualties by Age and Sex, and National Fire Data Center Fire in the United States 1989-1998 12th Edition)

There are devices currently available that are intended to shut off a stove's supply line or extinguish fire in the kitchen. The efficiency and cost effectiveness of these devices are questionable.

U.S. Pat. No. 4,834,188 discloses a fire extinguishing system for cook stoves and ranges device. It can cut off the flow of electricity or gas to the stove and trigger a built-in fire-extinguishing unit. But it is not capable of automatically detecting fires in the earliest developmental stages of a fire/carbon monoxide breakout. The occupants' actions are needed to prevent a full out fire. The expense of installation and manufacturing makes this system's commercialization virtually impossible.

U.S. Pat. No. 4,070,670 discloses an automatic shut-off and alarm for stove heating unit. The unit can shut off a gas stove's fuel supply line whenever the burner flame is extinguished by the spillage of water overflowing from the cooking utensil on the burner and the unburned gas is emitted. It uses a water drop detector’ to indirectly determine a gas leakage incident. This system cannot prevent fire, and gas leakage from other human errors or mechanical failure besides water spillage. It is also unsuitable to electric stoves.

Fire, smoke, and carbon monoxide alarms are increasingly used at homes and commercial buildings as the risks of fire and carbon monoxide poisoning continue to dominate for attention. As a result, many buildings and homes are required by law and building codes to install fire, smoke, or carbon monoxide alarms.

These alarms primarily utilize an audio alarm for warning the occupants of the residence the existence of the fire, smoke or carbon monoxide. The major flaw with these types of alarms is that they do not automatically prevent fire or carbon monoxide poisoning. Another setback with these audio alarms is that these alarms are not an effective warning device for the hearing impaired.

The smoke, fire, heat, and carbon monoxide alarm (along with all of the devices mentioned in above), cannot save lives or prevent fire, smoking damages, or gas explosions without an occupant's actions. Utility appliances get smoke and gas leakage from improper usage, mechanical failure, and unattended cooking. Consequences from these errors may occur if the occupants of the residence are not notified of the situation or if the occupants are sleeping. Other occurrences of fire cannot be prevented if the occupants are not present in the residence, working in an environment where warning sounds are hidden by ambient noises, or if the occupants are hearing impaired and action for preventing the fire is impossible (see above).

The Alarm Triggered Shut off Appliance System (ATSAS) uses the sound of alarms as the trigger signal to energize switch (either relay or gas solenoid valve) to shut off a utility appliance's supply line. Once the alarm sounds, the system can automatically shut off an appliance's gas or electricity supply in the earliest stages of development of a fire/carbon monoxide breakout or prevents their occurrences without any need for the occupants to take action. It can overcome the disadvantage of these prior arts and may save lives and billions of dollars lost on property damage.

The transmission methods between an alarm device and a shut off device could include direct connection through wires, radio frequency signals, audio sound, and ultrasonic signals.

The direct connection through wires between an alarm and a shut off device is a simple and reliable method. However, hiding the wiring behind the walls involves much labor and expense

Ultrasonic signals (Above 20 kHz) although not audible to humans, might create an uncomfortable situation for your pets (dogs especially). Ultrasonic transducers may be more expensive and harder to find than audio frequency devices

Radio frequency's' function is similar to ultrasonic signals with the disadvantage of easy interference. In the modern age, there are many wireless devices present in the home that would hinder the radio frequencies.

Very simple single on/off control can be accomplished with a simple burst of sound and a VOX (voice-operated switch) circuit, but may succumb to false triggering due environmental noises and other ambient noises.

All of the methods above cannot be implemented by with alarms in the market already, which do not provide other signals other than an alert sound. A newly designed alarm device or modifying marketed alarms is needed.

Sound transmission method can overcome issues and disadvantages that exist in the transmission methods mentioned above. It can establish signal transmission between marketed alarms and a shut off device.

There is a numerous amount of prior art on utilizing sound of alarms to activate fire safety devices or systems.

U.S. Pat. No. 4,524,304 and U.S. Pat. No. 4,570,155 disclose a smoke alarm activated light. The light bulb in the devices has adequate light to permit the occupants of the building to safety exit there from the time when a smoke alarm is activated.

U.S. Pat. No. 5,651,070 discloses a warning device programmable to be sensitive to pre-selected sound frequencies. The warning device detects audio sound from an activated alarm, and provides non-auditory type signals to the hearing impaired or those working in an environment where warning sounds are hidden by ambient noise. The non-auditory type signals can energize a noticeable signal device such as a visible light or by a source of vibration.

Over all, using sound of alarms as trigger signal is a practicable transmission method.

### SUMMARY OF THE INVENTION

This invention integrates everyday alarms into a tool for preventing deaths, injuries, and billions of dollars of property damage. The invention reduces the risks of fire and carbon monoxide poisoning before they occur without the occupants having to take any action. The present invention takes immediate action in preventing fire and carbon monoxide poisoning.

In accordance with an embodiment of this invention, a microphone transmits sound waves to a tone decoder that activates a switch circuit, turning an appliance off. The invention can be employed to detect a wide array of alarm sound frequencies given that the tone decode is adjustable, and its sensitivity to alert sound is also adjustable in order to fit a variety of situations.

In accordance with one embodiment of the present invention, a sound transmission method can overcome issues and disadvantages that exist in other transmission methods. There are no disadvantages in the present invention's transmission for such issues, as easy interference, false triggering, and pet discomfort do not apply to the sound transmission method.

The invention can be built in utility appliances as a safety feature.

One advantage to the present invention is its low cost. By using fire, smoke, heat, and carbon monoxide alarms that already exist in many homes, there is no need to buy additional items. The use of the present invention in combination with a utility appliance and an alarm can reduce the hazards of fire and carbon monoxide poisoning.

### BRIEF DESCRIPTION OF THE DRAWINGS

FIG. 1 is a block diagram of the Alarm Triggered Shut off Appliance System (ATSAS) integrated with alarms and utility appliances.

FIG. 2 is a schematic diagram of the control unit 100 of FIG. 1;

FIG. 3 is a schematic diagram of power switch (relay) unit 200 of FIG. 1; and

FIG. 4 is a schematic diagram of power switch (gas solenoid valve) unit 300 of FIG. 1.

### DETAILED DESCRIPTION

The Alarm Triggered Shut off Appliance System (ATSAS) can prevent fire and carbon monoxide poisoning caused by utility appliances. It shuts off appliance's supply (fuel and electricity) line when it detects warning sounds of smoke/heat/fire/carbon monoxide alarm device. It employs tone decoding technology to precisely recognize sound of alarms.

The system has a tone decoder that is in synchronized with the frequency range of the alarm's alert sound. The tone decoder prevents the system from being falsely activated by erroneous sounds. Once a smoke or gas leak occurs, the system detects the alert sound through its microphone, and energizes the power relay or solenoid valve that turns off the electric power or fuel gas supply to the utility appliance.

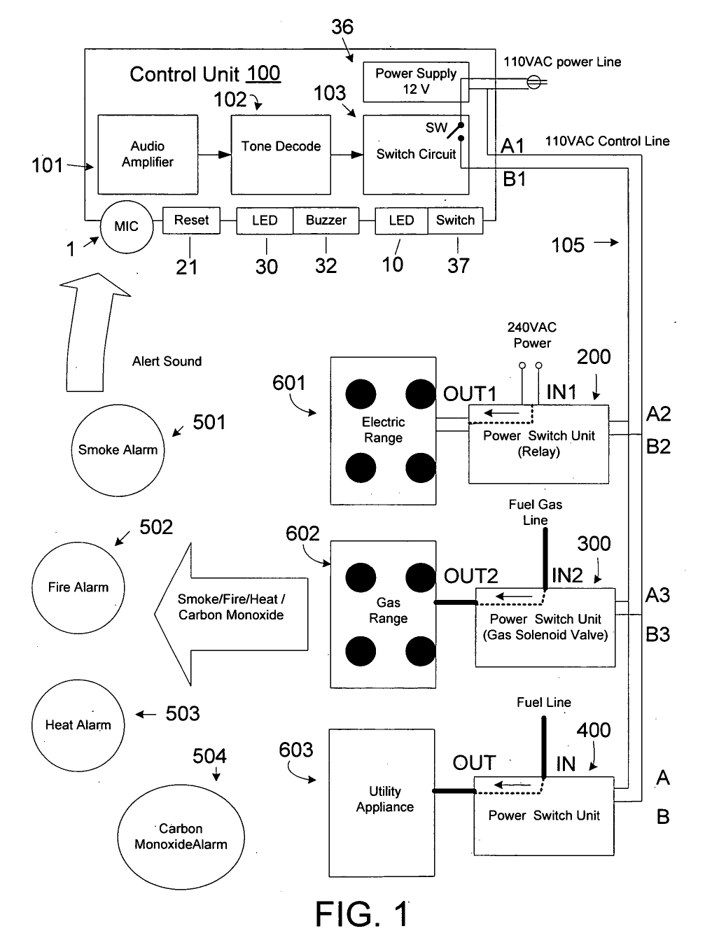

Referring to FIG. 1, The system includes of a control unit 100 and a power switch unit 200 (or 300). These two units 100, 200 could be housed in two separate enclosures or built inside of a utility appliance together. The power switch unit consists of two types; a relay is for electrical appliances, and a gas solenoid valve is for gas appliances. Both of the power switch units are normally open. One control unit 100 can manage multiple power switch units 200, 300.

Control unit 100 picks up a sound signal of an activated alarm 501 (any signal that warns or calls to action) by a microphone 1. The output of microphone 1 is connected to an input of an amplifier 101. Amplifier 101 amplifies the signal from microphone 1 and feeds the amplified signal to a tone decoder 102. If the signal is in the range of the predetermined frequency, tone decoder 102 provides a output signal to energize a switch circuit 103. The SW is closed. In sequence, a buzzer 32 and light emitting diode (LED) 30 are turned on to indicate the system's activation. At same time, the power switch unit 200 is energized by a 110VAC control line 105 to shut off an appliance 601's electricity or fuel gas supply line. After the problem is resolved, a reset button 21 should be pressed so that the system is ready for future use. A LED 10 is the system power indicator.

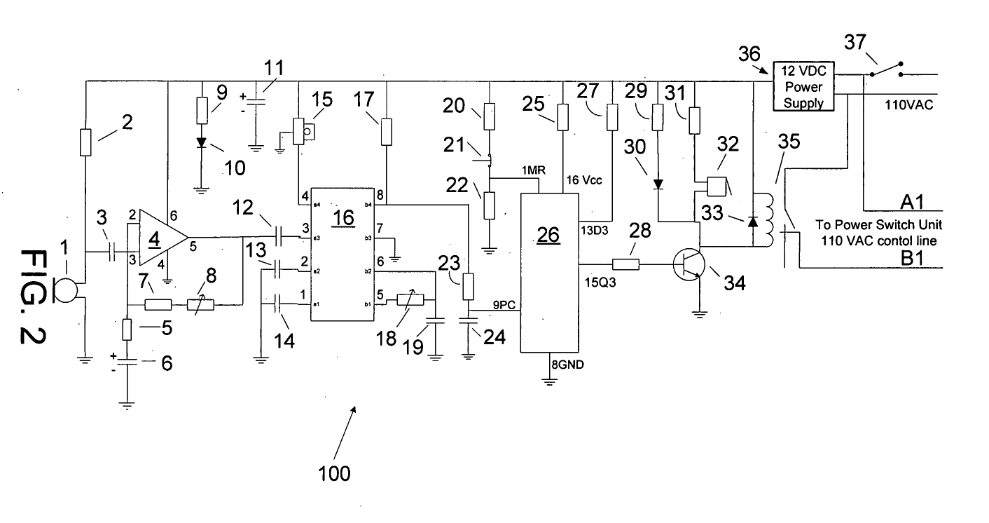

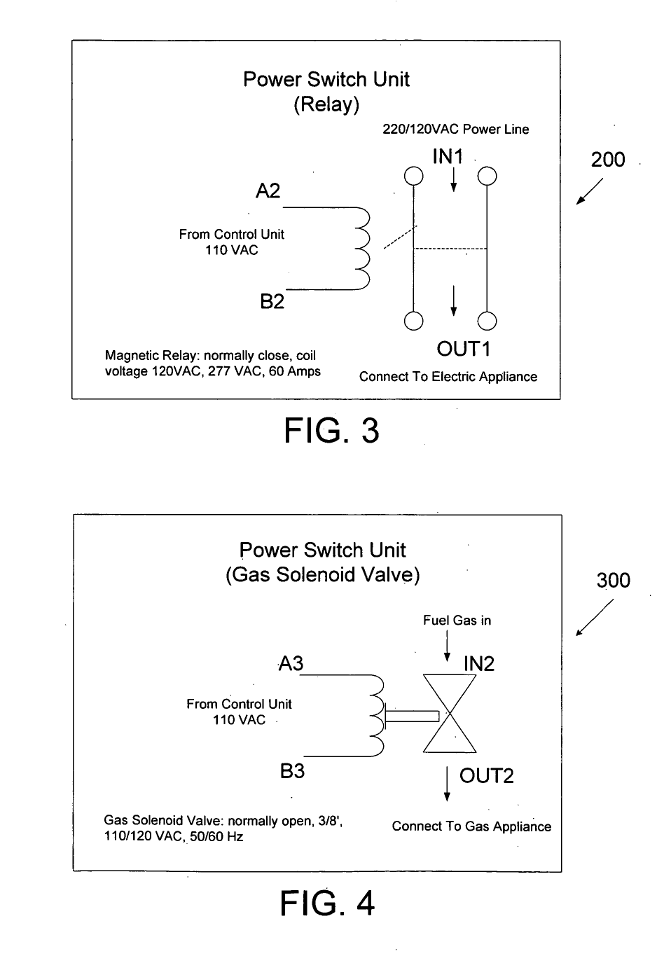

Referring to FIG. 2, sound is detected by microphone 1 and fed to an operational amplifier 4 via a capacitor 3. This is connected as a non-inverting amplifier. The gain of amplifier 4 can be adjusted by a potentiometer 8. Capacitor 3 prevents a DC current flow through operational amplifier 4. A resistor 2 provides power to microphone 1.

Operational amplifier 4 output pin 5 is connected to a tone decoder 16 input pin 3 via a capacitor 12. Tone decoder 16 is a general-purpose tone decoder designed to provide a saturated transistor switch to GND when an input signal is present within the pass band. The circuit includes I and Q detector driven by a voltage controlled oscillator which determines the center frequency of the decoder. The center frequency, Fₒ, can be determined by formula Fₒ=1/(1.1*resistance of resistor 18*capacitance of capacitor 19). The frequency bandwidth, BW, is determined by formula BW=1070*(Vᵢ/(Fₒ*capacitance of capacitor 13))^{1/2}*% of Fₒ. Vᵢ is input voltage (voltages rms).

A voltage regulator 15 provides tone decoder 16 a type power supply voltage. Tone decoder 16 center frequency can be changed by a potentiometer 18. Tone decoder 16 precision is accomplished by; Tone decoder 16 itself, voltage regulator 15, 20-turn tuning potentiometer 18. A capacitor 14 is used as a low pass filter to suppress out of band signals.

Tone decoder 16 output pin 8 is connected to a D-type flip-flops 26 input pin 9 via a RC circuit that is made of a resistor 23 and a capacitor 24. The RC circuit is intended to absorb erroneous pulse signals.

D-type flip-flops 26 has four edge-triggered, D-type flip-flops with individual D inputs and both Q and −Q. Just one of them is used to lock the signal from tone decoder 16 output pin 8. D-type flip-flops 26's master reset MR pin 1 resets D-type flip-flops 26 when its voltage from HIGH to LOW. A reset circuit consists of a resistor 20, a resistor 22 and a normally closed switch button 21. Since reset button 21 is normally closed and the value of resistor 20 is much smaller than value of resistor 22, the MR pin 1 keeps HIGH. When the reset button 21 is pressed to open, the MR pin 1 becomes LOW. D-type flip-flops 26 is reset.

D-type flip-flops 26's D3 pin 13 is HIGH as a result of a resistor 27 that is connected to positive power source. D-type flip-flops 26's PC pin 9 is clock input. Sounds of alarms are intermittent signals. When tone decoder 16 detects sounds in its predetermined frequency range, its output pin 8 generates a clock pulse signal to D-type flip-flops 26's PC pin 9. After the first period of the clock pulse signal (D-type flip-flops 26's PC pin 9 becomes HIGH from LOW), D-type flip-flops 26's Q3 pin 15 is triggered to HIGH (since D-type flip-flops 26's D3 pin 13 is HIGH). D-type flip-flops 26's Q3 pin 15 keeps HIGH (even the sound of alarm stops) until reset button 21 is pressed to reset.

D-type flip-flops 26's Q3 pin 15 is connected to a switch transistor 34 base via a resistor 28. Switch transistor 34 is close as D-type flip-flops 26's Q3 pin 15 is HIGH. It turns a buzzer 32 and a LED 30 on to indicate that the system was triggered. At the same time, it also energizes a relay 35. Relay 35 energizes the power switches by a 110 VAC control line terminal post A1/B1. Power switch unit shuts off the appliance's supply line. A resistor 29 provides power to LED 30. A resistor 31 provides power to buzzer 32.

A diode 33 protects transistors and integrated circuits from the brief high voltage ‘spike’ produced when relay 35 coil is switched off.

Terminal post A1 and B1 are connected to power switches terminal post A2/A3 and B2/A3 to energize power switch 200 or 300.

LED 10 is a system power indicator. It is on when a system switch 36 is turned on. A resistor 9 provides power to LED 10.

While the present invention has been particularly shown and described with reference to the preferred embodiment thereof, it will be understood by those skilled in the art that the foregoing and other changes in form and details may be made there in without departing from the spirit and scope of the present invention.

I claim:

1. An alarm triggered shut off appliance system including:
(a) a microphone for receiving audio tone signals emitted by an activated pre-existing distant alarm device, and for generating a responsive electric tone signal output;
(b) an amplifying means coupled to the output of said microphone for amplifying said electric tone signal output from said microphone;
(c) a tone decoding means coupled to the output of said amplifying means for reacting only to an alarm sound signal projected by the alarm device, and providing a decoding means output; and
(d) a switch means coupling said tone decoding means output and a utility appliances' supply lines for shutting off a utility appliance's supply line in response to said tone decoding means output.

2. The system of claim 1, wherein said microphone is a condenser microphone.

3. The system of claim 1, wherein said amplifying means includes an adjustable feedback loop for controlling the gain thereof to compensate for different microphone sensitivities, and a device selected from the group consisting of transistors and operational amplifier integrated circuits.

4. The system of claim 1, wherein said switch means includes a device selected from the group consisting of normally open gas solenoid valve and normally open relay for shutting off the utility appliances' supply lines.

5. An alarm triggered shut off appliance system including:
(a) a microphone for receiving audio alarm signals emitted by an activated pre-existing distant smoke or carbon monoxide alarm and for providing a responsive electrical signal output;
(b) a tone decoding means coupled to the output of said microphone for reacting only to a microphone electrical signal output in response to an alarm sound signal projected by an alarm device; and
(c) a switch means interconnecting the output of said tone decoding means and utility appliances' supply lines for shutting off a utility appliance's supply line when said tone decoding means reacts to an alarm sound signal.

6. The system of claim 5, wherein said microphone is a condenser microphone.

7. The system of claim 5, wherein said tone decoding means includes;
(a) an amplifier for amplifying electric tone signals from said microphone; and
(b) a tone decoder for reacting only to the alarm sound projected by an alarm device.

8. The system of claim 5, wherein said switch means includes a device selected from the group consisting of normally open gas solenoid valve and normally open relay for shutting off the utility appliances' supply lines.

9. The system of claim 7 wherein said amplifier includes an adjustable feedback loop for controlling the gain thereof to compensate for different microphone sensitivities, and a device selected from the group consisting of transistors and operational amplifier integrated circuits.

10. A method of activating a shut-off device in response to the sound from an alarm warning signal so as to prevent fire and gas related hazards from utility appliances including the steps of:
(a) converting said alarm warning signal into a warning electrical signal;
(b) decoding said electrical signal by reacting only to the sound from said alarm warning signal; and
(c) shutting off an energy supply line to the utility appliances in response a decoded electrical signal.
